(19) United States
(12) Patent Application Publication
(10) Pub. No.: US 2024/0100955 A1
(43) Pub. Date: Mar. 28, 2024

(54) LOW-VOLTAGE MITIGATION AND JUMPSTART RECOVERY OF MODACS USING ONBOARD HV PROPULSION SYSTEM POWER SOURCE

(71) Applicant: GM GLOBAL TECHNOLOGY OPERATIONS LLC, Detroit, MI (US)

(72) Inventors: Aaron B. BLOOM, Royal Oak, MI (US); Dave G. Rich, Sterling Heights, MI (US); Dewen Kong, Shanghai (CN); Jingyuan Liu, Shanghai (CN); Wing-Fai Ha, Markham (CA)

(21) Appl. No.: 18/350,073

(22) Filed: Jul. 11, 2023

(30) Foreign Application Priority Data
Sep. 28, 2022 (CN) 202211190125.6

(51) Int. Cl. B60L 3/00

(52) U.S. Cl. CPC B60L 3/0046

(57) ABSTRACT

A low-voltage mitigation and recovery system includes: an auxiliary power module that converts an output voltage of a power source of a vehicle to a charging voltage, the power source provides power to power a propulsion system of the vehicle; a contactor that supplies power from the power source to the auxiliary power module; a first control module that controls states of the auxiliary power module and the contactor. A second control module is integrated within a MODACS, monitors parameters of blocks of cells of the MODACS, and, based on at least one of the parameters: configures a switch network of the MODACS to disconnect a first set of blocks of the MODACS from loads and to connect or maintain connection of a second set of blocks of the MODACS to selected ones of the loads; and wakes up the first control module to jump start and recover the MODACS.

### CROSS-REFERENCE TO RELATED APPLICATIONS

This application claims the benefit of Chinese Patent Application No. 202211190125.6, filed on Sep. 28, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery management systems of vehicles.

Traditional vehicles include an internal combustion engine that generates propulsion torque. All electric vehicles include one or more electric motors for propulsion and no internal combustion engine. Hybrid vehicles can include both an internal combustion engine and one or more electric motors for propulsion. The one or more electric motors are used to improve fuel efficiency. One or more electric motors and an internal combustion engine can be used in combination to achieve greater torque output than using only the internal combustion engine.

Example types of hybrid vehicles are parallel hybrid vehicles, series hybrid vehicles, and mixture mode hybrid vehicles that include a combination of parallel and serial connected drive systems. In a parallel hybrid vehicle, an electric motor can work in parallel with an engine to combine power and range advantages of the engine with efficiency and regenerative braking advantages of the electric motor. In a series hybrid vehicle, an engine drives a generator to produce electricity for an electric motor, which drives a transmission. This allows the electric motor to assume some of the power responsibilities of the engine, which in turn allows for use of a smaller more fuel-efficient engine.

### SUMMARY

A low-voltage mitigation and recovery system is disclosed and includes: an auxiliary power module configured to convert an output voltage of a power source of a vehicle to a charging voltage, the power source configured to provide power to power a propulsion system of the vehicle; a contactor configured to supply power from the power source to the auxiliary power module; a first control module configured to control states of the auxiliary power module and the contactor; and a second control module. The second control module is configured to be integrated within a multiple output dynamic adjustable capacity battery system (MODACS) of the vehicle, monitor at least one parameter of one or more blocks of cells of the MODACS, and, based on at least one parameter of the one or more blocks of cells of the MODACS, i) configure a switch network of the MODACS to (a) disconnect a first set of blocks of the MODACS from loads of the vehicle, and (b) connect or maintain connection of a second set of blocks of the MODACS to selected ones of the loads, and ii) wake up the first control module to jump start and recover the MODACS.

In other features, the second control module in response to: the at least one parameter being less than a first predetermined voltage, (a) disconnects the first set of blocks from the loads of the vehicle, and (b) connects or maintains connection of the second set of blocks to the selected ones of the loads; and the at least one parameter being less than a second predetermined voltage, wakes up the first control module to jump start and recover the MODACS.

In other features, the first control module is configured to in response to receiving a wake-up signal from the second control module to jump start and recover the MODACS, close the contactor and instruct the auxiliary power module to output a minimum voltage for charging the MODACS.

In other features, the first control module is configured to ramp up an output voltage of the auxiliary power module at a selected rate.

In other features, the second control module is configured to close one or more of switches of the switch network to begin charging a selected at least one block of cells of the MODACS in response to the output voltage of the auxiliary power module exceeding a voltage of the selected one or more blocks of cells by a predetermined amount.

In other features, the selected at least one block of cells includes the selected one or more blocks of cells.

In other features, the second control module is configured to wake up the first control module in response to a voltage of the one or more blocks being within 0.1V of an undervoltage calibration voltage.

In other features, the second control module is configured to determine whether at least one block of cells of the MODACS is charging appropriately during recovery of the MODACS, and in response to the at least one block of cells charging appropriately, increase a charging rate of the second set of blocks.

In other features, the second control module is configured to determine whether a state-of-charge of the at least one block of cells of the MODACS is greater than a first predetermined state-of-charge, and in response to the at least one block of cells of the MODACS being greater than the first predetermined state-of-charge, connect the first set of blocks to charge the first set of blocks.

In other features, the second control module is configured to determine whether at least one block of cells of the MODACS is charging appropriately during recovery of the MODACS, and in response to the at least one block of cells charging inappropriately, operate in an undervoltage protection mode.

In other features, a low-voltage mitigation and recovery system is disclosed and includes: an auxiliary power module configured to convert an output voltage of a power source of a vehicle to a charging voltage, the power source configured to provide power to power a propulsion system of the vehicle; a contactor configured to supply power from the power source to the auxiliary power module; a vehicle control module configured to control states of the auxiliary power module and the contactor; and a control module. The control module is configured to be integrated within a battery of the vehicle, monitor at least one parameter of one or more blocks of cells of the battery, and, based on at least one parameter of one or more blocks of cells of the battery, i) configure a switch network of the battery to (a) disconnect a first set of blocks of the MODACS from loads of the vehicle, and (b) connect or maintain connection of a second set of blocks of the MODACS to selected ones of the loads, and ii) wake up the vehicle control module to jump start and recover the battery.

In other features, a method of operating a low-voltage mitigation and recovery system is disclosed. The low-voltage mitigation and recovery system includes an auxiliary power module, a contactor, a first control module and a second control module. The auxiliary power module is configured to convert an output voltage of a power source of a vehicle to a charging voltage. The power source is configured to provide power to power a propulsion system of the vehicle. The contactor is configured to supply power from the power source to the auxiliary power module. The first control module is configured to control states of the auxiliary power module and the contactor. The second control module is integrated within a multiple output dynamic adjustable capacity battery system (MODACS) of the vehicle. The method includes: monitoring, via the second control module, at least one parameter of one or more blocks of cells of the MODACS; and based on at least one parameter of the one or more blocks of cells of the MODACS, i) configuring a switch network of the MODACS to (a) disconnect a first set of blocks of the MODACS from loads of the vehicle, and (b) connect or maintain connection of a second set of blocks of the MODACS to selected ones of the loads, and ii) waking up the first control module to jump start and recover the MODACS.

In other features, the method further includes via the second control module and in response to: the at least one parameter being less than a first predetermined voltage, (a) disconnecting the first set of blocks from the loads of the vehicle, and (b) connecting or maintaining connection of the second set of blocks to the selected ones of the loads; and the at least one parameter being less than a second predetermined voltage, waking up the first control module to jump start and recover the MODACS.

In other features, the method further includes, via the first control module and in response to receiving a wake-up signal from the second control module to jump start and recover the MODACS, closing the contactor and instructing the auxiliary power module to output a minimum voltage for charging the MODACS.

In other features, the method further includes, via the first control module, ramping up an output voltage of the auxiliary power module at a selected rate.

In other features, the method further includes, via the second control module, closing one or more of switches of the switch network to begin charging a selected at least one block of cells of the MODACS in response to the output voltage of the auxiliary power module exceeding a voltage of the selected one or more blocks of cells by a predetermined amount.

In other features, the method further includes, via the second control module, waking up the first control module in response to a voltage of the one or more blocks being within 0.1V of an undervoltage calibration voltage.

In other features, the method further includes, via the second control module, determining whether at least one block of cells of the MODACS is charging appropriately during recovery of the MODACS, and in response to the at least one block of cells charging appropriately, increasing a charging rate of the second set of blocks.

In other features, the method further includes, via the second control module, determining whether a state-of-charge of the at least one block of cells of the MODACS is greater than a first predetermined state-of-charge, and in response to the at least one block of cells of the MODACS being greater than the first predetermined state-of-charge, connecting the first set of blocks to charge the first set of blocks.

In other features, the method further includes, via the second control module, determining whether at least one block of cells of the MODACS is charging appropriately during recovery of the MODACS, and in response to the at least one block of cells charging inappropriately, operating in an undervoltage protection mode.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example low-voltage mitigation and recovery system in accordance with the present disclosure;

FIG. 2 is a functional block diagram of an example multiple output dynamic adjustable capacity battery system (MODACS) in accordance with the present disclosure;

FIGS. 3A-3B are a schematic including an example implementation of a MODACS in accordance with the present disclosure;

FIG. 4 is a functional block diagram of an example vehicle including a MODACS and a vehicle control module in accordance with the present disclosure;

FIG. 5 is a functional block diagram of an example control portion of a vehicle control system in accordance with the present disclosure;

FIG. 6 a schematic of an example portion of a MODACS circuit in accordance with the present disclosure;

FIGS. 7A-7B (collectively FIG. 7) illustrates a low-voltage mitigation and recovery method in accordance with the present disclosure;

FIG. 8 is a functional block diagram of an example battery monitoring (or management) system (BMS) module for a battery pack in accordance with the present disclosure;

FIG. 9 is an example plot of auxiliary power module (APM) voltage versus time in accordance with the present disclosure; and

FIG. 10 is an example plot of a MODACS voltage versus time in accordance with the present disclosure.

In the drawings, reference numbers may be reused to identify similar and/or identical elements.

### DETAILED DESCRIPTION

A MODACS includes blocks (or strings) of cells. The cells may be connected in series and/or in parallel. The blocks of cells may be connected in series and/or in parallel to provide various output voltages, such as 12V and 48V to power 12V loads and 48V loads. The blocks of cells may be grouped. Each group of blocks of cells may be referred to as a module (or battery module). A MODACS may have multiple battery modules. A MODACS may be implemented as a single battery having a corresponding housing with a negative (or ground reference) terminal and multiple source terminals. Each of the source terminals of a MODACS may have a preset direct current (DC) voltage (e.g., 12 volts (V), 24V, 36V, 48V, etc.) and may supply (or discharge) current or receive current during charging. As an example, the MODACS may include a single 48V source terminal, a first 12V source terminal and a second 12V source terminal.

A battery electric vehicle (BEV) may include a high-voltage power source (e.g., battery pack providing 400V, 800V, etc.), an APM, and a MODACS. The high-voltage power source is used primarily for propulsion purposes to provide power to electric motors to propel a host vehicle. The MODACS is primarily used to supply low-voltage power to various loads, such as nominal loads, auxiliary loads, transient loads, and leakage current loads. Nominal loads refer to steady-state loads that are typically ON and draw a consistent small amount of power (e.g., 20-30 watts). Example nominal loads are: vehicle controllers, such as engine, transmission, brake, and body controllers; a vehicle cluster; a vehicle dashboard; a display screen; a shifter; etc. Auxiliary loads refer to features that are turned on by a user and/or are associated with autonomous vehicle control. Some examples of auxiliary loads are windshield wiper motors, heated seats, and a semi-autonomous driver assistance module and corresponding devices configured to perform semi-autonomous vehicle control operations.

Transient loads refer to loads that draw sudden bursts of power. As an example, an engine starter can draw a large amount of power for a short period of time. Leakage current loads refer to parasitic current draw from electrical devices and components when OFF or in a sleep mode. Electrical devices and components can exhibit parasitic current draw unless decoupled from the corresponding power source.

When a BEV is in a parked “at rest” state for an extended period of time, a state-of-charge (SOC) of a MODACS can decrease. This is due to power being drawn from the MODACS and the MODACS not being charged by, for example, a high-voltage power source. When at rest, the propulsion system of the BEV is OFF and the high-voltage power source is not connected to and charging the MODACS. While in this state, power may be drawn from the MODACS by nominal loads, auxiliary loads, and/or leakage current loads. With vehicles becoming more electrically complex, additional parasitic loads can exist on a vehicle and cause a MODACS to discharge when at rest. If the SOC decreases to a predetermined threshold, the vehicle may need a “jumpstart” and/or to be provided with an external power source to at least close contactors (e.g., 12V contactors) and/or other switches to allow host vehicle systems to charge the MODACS.

The examples set forth herein include a low-voltage mitigation and recovery system that monitors parameters of a MODACS and when certain conditions arise, perform mitigation operations to reduce draw on the MODACS and/or to perform recovery operations to charge the MODACS. The examples include, when the parameters are indicative of the MODACS being in a first low-voltage state (e.g., less than a first predetermined voltage (e.g., 10.5-11.5V)), disconnecting selected blocks of the MODACS from one or more selected types of loads and/or one or more specifically selected loads. This is done to reduce and/or stop power draw from the selected blocks. Different blocks may be selectively disconnected from different loads. The examples further provide an automatic jumpstart of the MODACS when the parameters are indicative of the MODACS being in a second low-voltage state (e.g., less than a second predetermined voltage (e.g., less than 10.0V-10.5V). The second predetermined voltage is less than the first predetermined voltage. These features are further described below.

The implementations disclosed herein may be applied to internal combustion engine (ICE) vehicles, fully electric vehicles, battery electric vehicles (BEVs), hybrid electric vehicles including plug-in hybrid electric vehicles (PHEVs), partially or fully autonomous vehicles, and other types of vehicles including a MODACS.

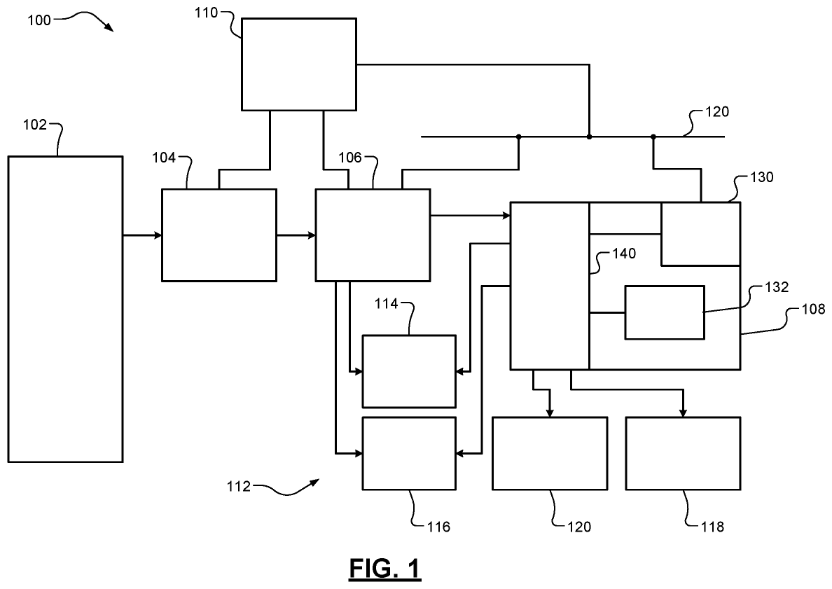

FIG. 1 shows a low-voltage mitigation and recovery system 100 that includes a high-voltage (HV) power source 102, a contactor 104, an APM 106, a MODACS 108, a vehicle control module 110 and loads 112. The loads 112 may include nominal loads 114, auxiliary loads 116, transient loads 118 and leakage current loads, represented by box 120. The leakage current loads 120 may refer to power drawn from electrical and/or electronic devices, modules and components that are connected to the MODACS 108 and are in an OFF state. The leakage current loads 120 may include any of the nominal loads 114, auxiliary loads 116 and transient loads 118 and when OFF exhibit parasitic current draw of a small amount of power (e.g., 10s-100s of micro-amps per hour).

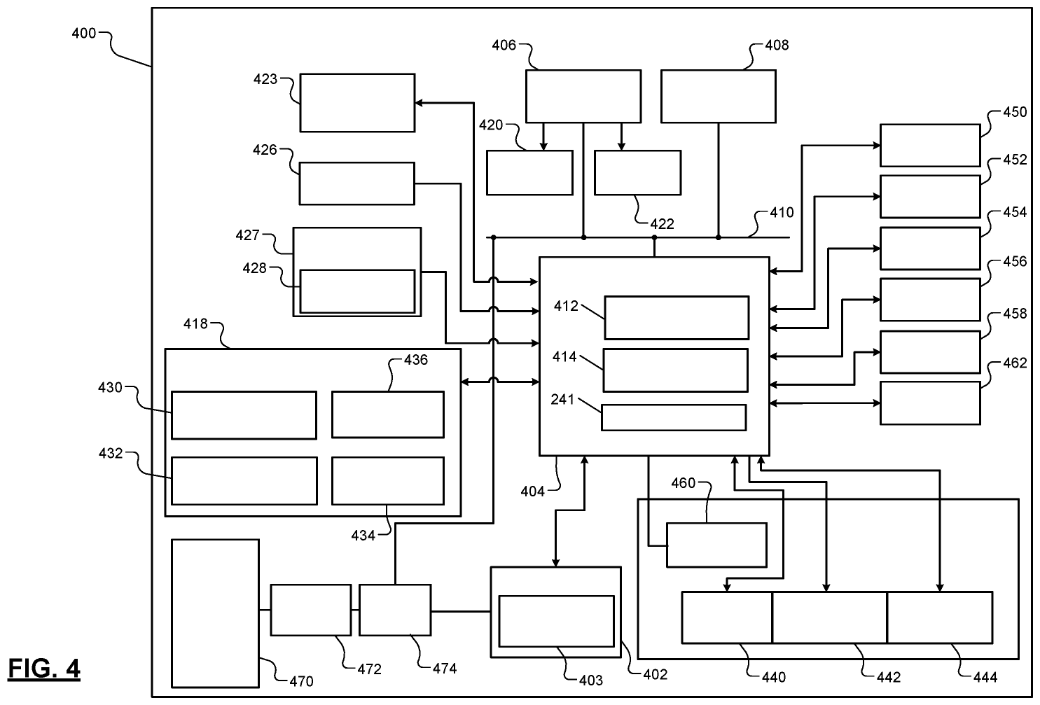

The HV power source 102 may be a HV battery pack for supplying 400V, 800V or other high voltage to power motors of a propulsion system, such as that shown in FIG. 4. The HV power source 102 supplies power to the APM 106 via the contactor 104. The contactor 104 may be a rechargeable energy storage system (RESS) contactor. The APM 106 converts a high-voltage out of the HV power source 102 to a second voltage (e.g., 12V or 48V), which is supplied to charge the MODACS 108. The APM 106 may supply power to some of the loads 112.

The vehicle control module 110 may be implemented as a vehicle integration control module (VICM), a battery control module (BCM), or other vehicle control module. The vehicle control module 110 controls states of the contactor 104 and the APM 106. As described below, the vehicle control module 110 may wake up the APM 106 and close the contactor 104 during certain conditions to charge the MODACS 108.

The APM 106, MODACS 108 and vehicle control module 110 may communicate with each other via a network bus 120, such as a controller area network (CAN) bus. The network bus 120 may be connected to a MODACS control module 130 of the MODACS 108. The MODACS control module 130 monitors voltages, temperatures, SOCs and other parameters of blocks 132 of the MODACS 108 and may operate in a low-voltage mitigation mode and/or a recovery mode. While in the low-voltage mitigation mode and based on the monitored parameters, the MODACS control module 130 partially or fully disconnects the blocks 132 from the loads 112. The partial disconnecting of blocks includes disconnecting a selected one or more of the blocks 132 from a selected one or more of the loads 112. The full disconnecting of blocks includes disconnecting a selected one or more of the blocks 132 from all of the loads 112. While in the recovery mode, the MODACS control module 130 signals the vehicle control module 110 to provide power from the HV power source to charge at least some of the blocks 132. During the recovery mode, all of the blocks may be charged. The charging of the blocks is further described below.

The MODACS 108 also includes a switch network 140 for selectively connecting the blocks 132 in series, in parallel and to selected loads. The MODACS 108 and/or the switch network 140 may include multiple input/output terminals and voltage busses for supplying one or more different voltages to different loads. The MODACS control module 130 controls states of switches of the switch network 140 to connect and disconnect the blocks 132 to and from the stated voltage busses and input/output terminals.

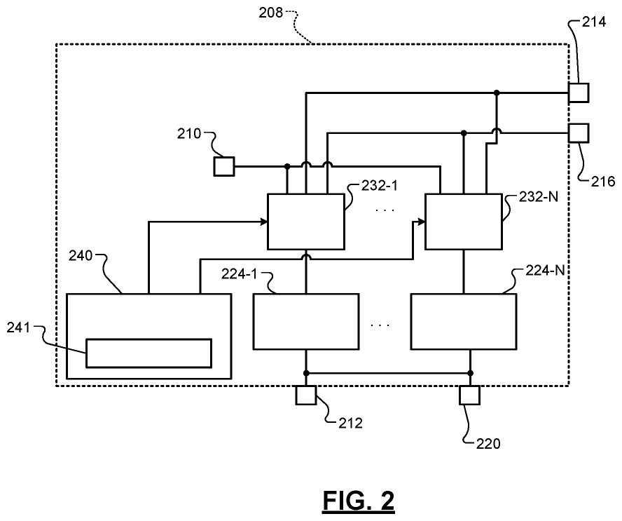

A MODACS control module 130 may be attached to, implemented in or be connected externally to the housing of the MODACS 108. In one embodiment, the MODACS control module 130 is integrated in the housing of the MODACS 108. An example MODACS control module and example vehicle control modules are shown in FIGS. 2-6.

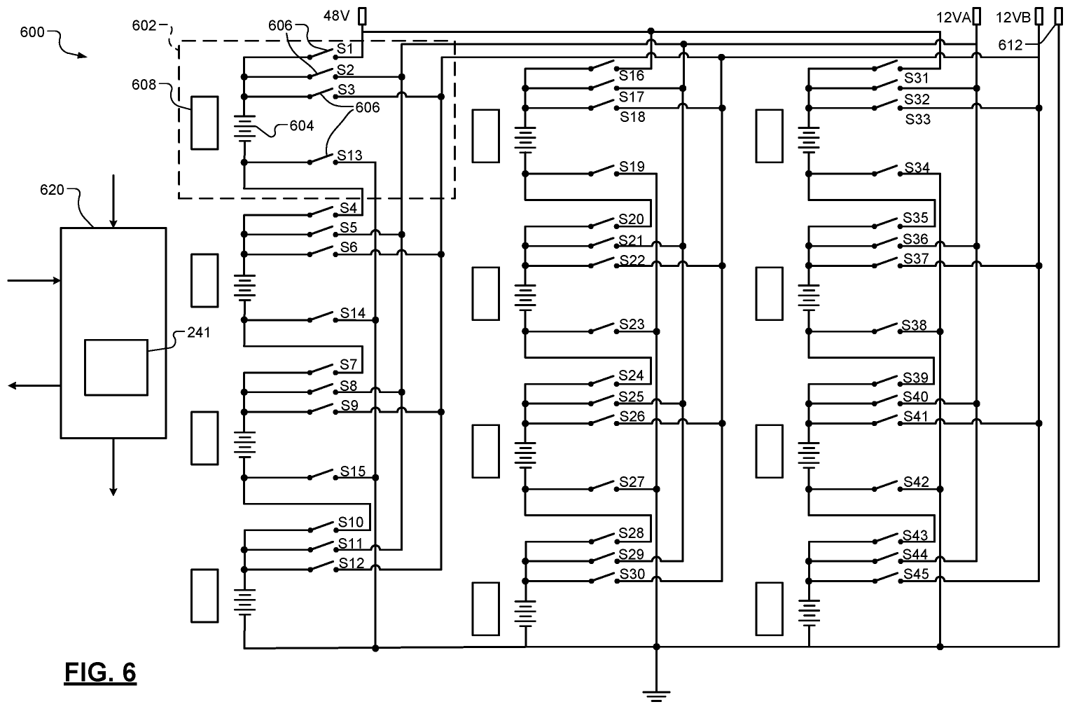

The housing of the MODACS 108 may include switches and battery monitoring (or management) system (BMS) modules. The switches and BMS modules may be connected to and/or implemented separate from the cells. The MODACS control module 130 controls operating states of the switches to connect selected ones of the cells to the source terminals based on information from the BMS modules. BMS modules are shown in FIG. 6. Any number of the cells, blocks and/or battery modules may be selected and connected to each of the source terminals at any moment in time. The cells, blocks and battery modules may be connected: in series and/or in parallel; in different connected configurations; and may be organized into blocks, packs, and/or groups. Each block may include one or more cells, which may be connected in series and/or in parallel. Each pack may include one or more blocks, which may be connected in series and/or in parallel. Each group may include one or more packs, which may be connected in series and/or in parallel. The groups may be connected in series and/or in parallel. A battery module may refer to one or more packs and/or one or more groups.

Each of the BMS modules may be assigned to one or more cells, one or more blocks, one or more packs, and/or one or more groups and monitor corresponding parameters, such as voltages, temperatures, current levels, SOXs, instantaneous power and/or current limits, short-term power and/or current limits, and/or continuous power and/or current limits. The acronym “SOX” refers to a state of charge (SOC), a state of health (SOH), state of power (SOP), and/or a state of function (SOF). The SOC of a cell, pack and/or group may refer to the voltage, current and/or amount of available power stored in the cell, pack and/or group. The SOH of a cell, pack and/or group may refer to: the age (or operating hours); whether there is a short circuit; whether there is a loose wire or bad connection; temperatures, voltages, power levels, and/or current levels supplied to or sourced from the cell, pack and/or group during certain operating conditions; and/or other parameters describing the health of the cell, pack and/or group. The SOF of a cell, pack and/or group may refer to a current temperature, voltage, and/or current level supplied to or sourced from the cell, pack and/or group, and/or other parameters describing a current functional state of the cell, pack and/or group.

Instantaneous power and current limits may refer to power and current limits for a short period of time (e.g., less than 2 seconds). Short term power and current limits may refer to power and current limits for an intermediate length of time (e.g., 2-3 seconds). Continuous power and current limits refer to power and current limits for an extended period of time (e.g., periods greater than 3 seconds).

A MODACS control module 130 controls the states of the switches to connect the cells to the source terminals while satisfying target and/or requested voltages, currents and power capacities. The MODACS control module 130 and/or a vehicle control module may set the target and/or requested voltages, currents and power capacities, for example, based on a mode of operation. The MODACS 108 may operate in different operating modes, which correspond to vehicle operating modes, as described below. The MODACS operating modes may include, for example, a low-voltage mitigation mode, a recovery mode, a regenerative mode, a boost mode, an autostart mode, and/or other MODACS charge or discharge modes. The vehicle operating modes may include an electric vehicle launch mode, an engine start mode, an engine assist mode, an opportunity charging mode, a deceleration fuel cut-off (DFCO) regenerative mode, an electric vehicle regenerative mode (e.g., a generator DFCO regenerative mode or a brake regenerative mode), an electric vehicle cruise mode, and/or other vehicle operating mode. Additional vehicle operating modes are described below. Each of the vehicle operating modes corresponds to one of the MODACS modes.

FIG. 2 shows a MODACS 208, which may be configured similarly as and/or replace the MODACS 108 of FIG. 1. The MODACS 208 may be implemented as a single battery having multiple source terminals. Three example source terminals 210, 214, 216 are shown, although any number of source terminals may be included. The source terminals, which may be referred to as positive output terminals, provide respective direct current (DC) operating voltages. The MODACS 208 may include only one negative terminal or may include a negative terminal for each source terminal. For example only, the MODACS 208 may have a first positive (e.g., 48 Volt (V)) terminal 210, a first negative terminal 212, a second positive (e.g., a first 12V) terminal 214, a third positive (e.g., a second 12V) terminal 216, and a second negative terminal 220. While the example of the MODACS 208 having a 48V operating voltage and two 12V operating voltages is provided, the MODACS 208 may have one or more other operating voltages, such as only two 12V operating voltages, only two 48V operating voltages, two 48V operating voltages and a 12V operating voltage, or a combination of two or more other suitable operating voltages. As another example, the operating voltages may range from 12V-144V.

The MODACS 208 includes cells and/or blocks of cells, such as a first block (or string) 224-1 to an N-th block (or string) 224-N (“blocks 224”), where N is an integer greater than or equal to 2. Each of the blocks 224 may include one or more cells. Each block may also be separately replaceable within the MODACS 208. For example only, each of the blocks 224 may be an individually housed 12V DC battery. The ability to individually replace the blocks 224 may enable the MODACS 208 to include a shorter warranty period and have a lower warranty cost. The blocks 224 are also individually isolatable, for example, in the event of a fault in a block. In various implementations, the MODACS 208 may have the form factor of a standard automotive grade 12V battery.

Each of the blocks 224 has its own separate capacity (e.g., in amp hours, Ah). The MODACS 208 includes switches, such as first switches 232-1 to 232-N (collectively “switches 232”). The switches 232 enable the blocks 224 to be connected in series, parallel, or combinations of series and parallel to provide desired output voltages and capacities at the output terminals. Although examples of some switches are shown, other switches may be included to perform the various operations disclosed herein.

A MODACS control module 240 is shown and may include an active safety module (ASM) 241 and may control the switches 232 to provide desired output voltages and capacities at the source terminals. The MODACS control module 240 may be configured similarly as the MODACS control module 130 of FIG. 1. The MODACS control module 240 controls the switches 232 to vary the capacity provided at the source terminals based on a present operating mode of the vehicle, as discussed further below. The ASM module 241 may also control the stated switches 232 to disconnect, isolate, discharge, test and/or reconnect blocks of cells from the power grid, which includes the other blocks of cells, source terminals, negative terminals, etc. Operations of the ASM module 241 are further described below.

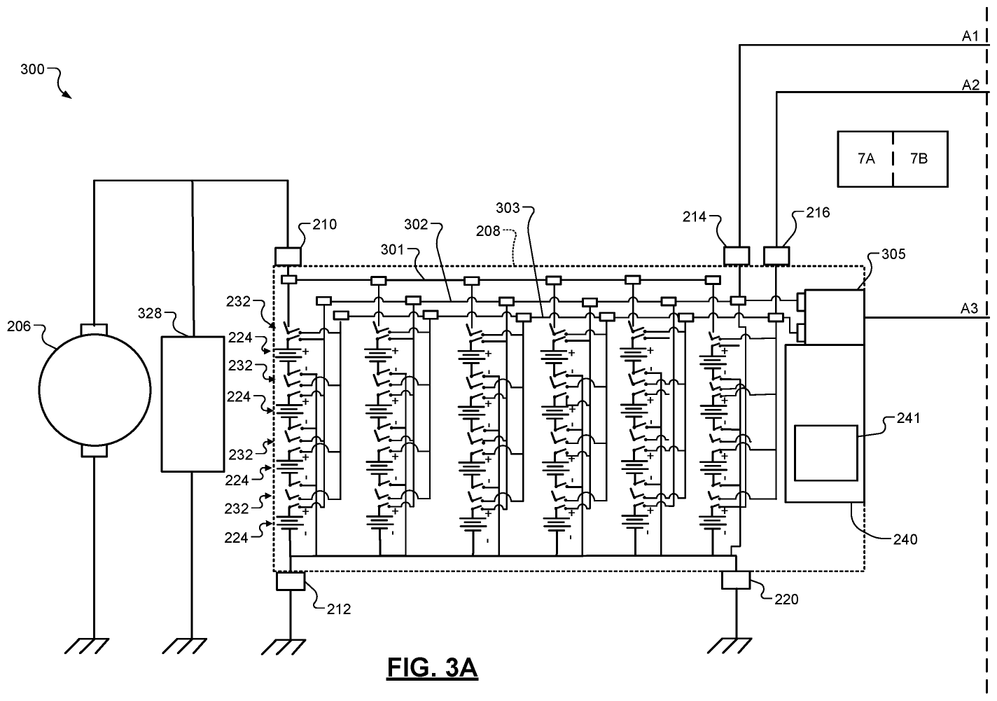

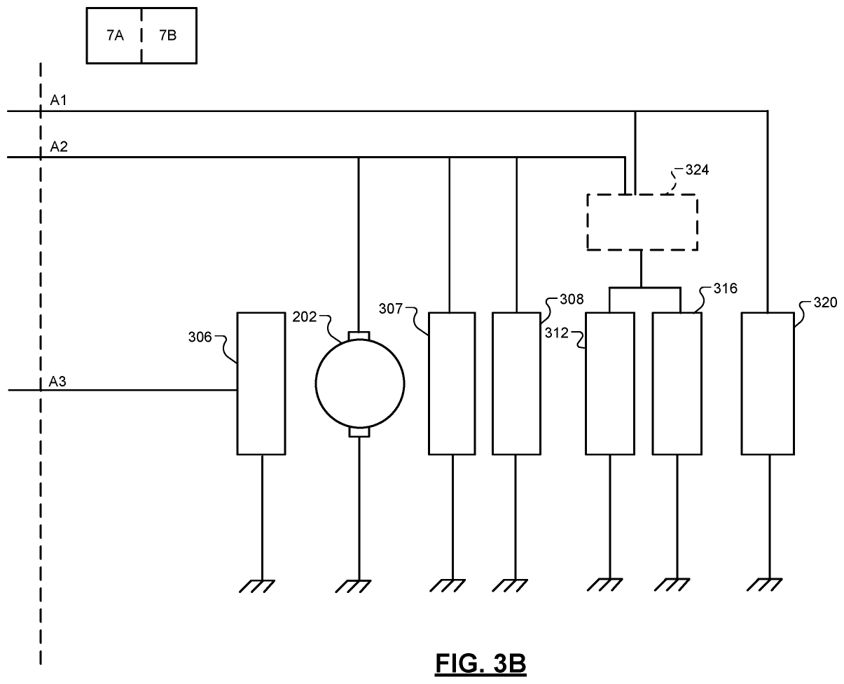

FIGS. 3A-3B show a vehicle electrical system 300 including an example implementation of the MODACS 208. The MODACS 208 includes the source terminals 210, 214, 216, respective power rails 301, 302, 303, a MODACS control module 240, and a power control circuit 305, which may be connected to the MODACS control module 240 and vehicle control module (VCM) and/or BCM 306. Power rail 303 may be a redundant power rail and/or used for different loads than the power rail 302. The MODACS control module 240 including the ASM module 241, the power control circuit 305, the VCM and/or the BCM 306 may communicate with each other via a controller area network (CAN), a local interconnect network (LIN), a serial network, wirelessly and/or another suitable network and/or interface. The MODACS control module 240 may communicate with the VCM and/or BCM 306 directly or indirectly via the power control circuit 305 as shown.

In the example of FIG. 3A, sets of 4 of the blocks 224 (e.g., 12V blocks) are connectable in series (via ones of the switches 232) to the first positive terminal 210 and the first negative terminal 212 to provide a first output voltage (e.g., 48V). Individual ones of the blocks 224 may be connected (via ones of the switches 232) to the second positive terminal 214 or the third positive terminal 216 and the second negative terminal 220 to provide a second output voltage (e.g., 12V) at the second and third positive terminals 214 and 216. How many of the blocks 224 are connected to the first positive terminal 210, the second positive terminal 214, and the third positive terminal 216 dictates the portions of the overall capacity of the MODACS 208 available at each of the positive terminals. Any number of the blocks may be connected in series and any number of series sets may be connected in parallel. In the example of FIG. 3A, the blocks 224 are shown with battery symbols. Each block may include, as an example, four cells, where each cell is connected in series and is a lithium ion cell (e.g., a lithium iron battery (LFP) cell with a nominal voltage at 3.2V).

As shown in FIG. 3B, a first set of vehicle electrical components operates using one of the two or more operating voltages of the MODACS 208. For example, the first set of vehicle electrical components may be connected to the second and third positive terminals 214 and 216. Some of the first set of vehicle electrical components may be connected to the second positive terminal 214, and some of the first set of vehicle electrical components may be connected to the third positive terminal 216. The first set of vehicle electrical components may include, for example but not limited to, the VCM and/or BCM 306 and other control modules of the vehicle, the starter motor 202, and/or other electrical loads, such as first 12V loads 307, second 12V loads 308, other control modules 312, third 12V loads 316, and fourth 12V loads 320. In various implementations, a switching device 324 may be connected to both of the first and second positive terminals 214. The switching device 324 may connect the other control modules 312 and the third 12V loads 316 to the second positive terminal 214 or the third positive terminal 216.

As shown in FIG. 3A, a second set of vehicle electrical components operates using another one of the two or more operating voltages of the MODACS 208. For example, the second set of vehicle electrical components may be connected to the first positive terminal 210. The second set of vehicle electrical components may include, for example but not limited to, the generator 206 and various electrical loads, such as 48V loads 328. The generator 206 may be controlled to recharge the MODACS 208.

Each of the switches 232 may be an insulated gate bipolar transistor (IGBT), a field effect transistor (FET), such as a metal oxide semiconductor FET (MOSFET), or another suitable type of switch.

FIG. 4 shows a vehicle 400 including a MODACS 402 and a vehicle control module 404. The MODACS 402 may replace and/or operate similarly as the MODACS 108, 208 of FIGS. 1-3B. The MODACS 402 includes a MODACS control module 403. The vehicle 400 includes a vehicle control module 404, an infotainment module 406 and other control modules 408. The modules 403, 404, 406, 408 may communicate with each other via a controller area network (CAN) bus 410 and/or other suitable interfaces. The vehicle control module 404 may control operation of vehicles systems. The vehicle control module 404 may include a mode selection module 412, a parameter adjustment module 414, as well as other modules. The mode selection module 412 may select a vehicle operating mode, such as one of the vehicle operating modes stated above. The parameter adjustment module 414 may be used to adjust parameters of the vehicle 400.

The vehicle 400 may further include: a memory 418; a display 420; an audio system 422; one or more transceivers 423 including sensors 426; and a navigation system 427 including a global positioning system (GPS) receiver 428. The sensors 426 may include sensors, cameras, objection detection sensors, temperature sensors, accelerometers, vehicle velocity sensor, and/or other sensors. The GPS receiver 428 may provide vehicle velocity and/or direction (or heading) of the vehicle and/or global clock timing information.

The memory 418 may store sensor data 430 and/or vehicle parameters 432, MODACS parameters 434, and applications 436. The applications 436 may include applications executed by the modules 403, 404, 406, 408. Although the memory 418 and the vehicle control module 404 are shown as separate devices, the memory 418 and the vehicle control module 404 may be implemented as a single device.

The vehicle control module 404 may control operation of an engine 440, a converter/generator 442, a transmission 444, a window/door system 450, a lighting system 452, a seating system 454, a mirror system 456, a brake system 458, electric motors 460 and/or a steering system 462 according to parameters set by the modules 403, 404, 406, 408. The vehicle control module 404 may set some of the parameters based on signals received from the sensors 426. The vehicle control module 404 may receive power from the MODACS 402, which may be provided to the engine 440, the converter/generator 442, the transmission 444, the window/door system 450, the lighting system 452, the seating system 454, the mirror system 456, the brake system 458, the electric motors 460 and/or the steering system 462, etc. Some of the vehicle control operations may include unlocking doors of the window/door system 450, enabling fuel and spark of the engine 440, starting the electric motors 460, powering any of the systems 450, 452, 454, 456, 458, 462, and/or performing other operations as are further described herein.

The engine 440, the converter/generator 442, the transmission 444, the window/door system 450, the lighting system 452, the seating system 454, the mirror system 456, the brake system 458, the electric motors 460 and/or the steering system 462 may include actuators controlled by the vehicle control module 404 to, for example, adjust fuel, spark, air flow, steering wheel angle, throttle position, pedal position, door locks, window position, seat angles, etc. This control may be based on the outputs of the sensors 426, the navigation system 427, the GPS receiver 428 and the above-stated data and information stored in the memory 418.

The vehicle control module 404 may determine various parameters including a vehicle speed, an engine speed, an engine torque, a gear state, an accelerometer position, a brake pedal position, an amount of regenerative (charge) power, an amount of boost (discharge) power, an amount of auto start/stop discharge power, and/or other information, such as priority levels of source terminals of the MODACS 402, power, current and voltage demands for each source terminal, etc. The vehicle control module 404 may share this information and the vehicle operating mode with the MODACS control module 403. The MODACS control module 403 may determine other parameters, such as: an amount of charge power at each source terminal; an amount of discharge power at each source terminal; maximum and minimum voltages at source terminals; maximum and minimum voltages at power rails, cells, blocks, packs, and/or groups; SOX values cells, blocks, packs, and/or groups; temperatures of cells, blocks, packs, and/or groups; current values of cells, blocks, packs, and/or groups; power values cells, blocks, packs, and/or groups; etc. The MODACS control module 403 may determine connected configurations of the cells and corresponding switch states as described herein based on the parameters determined by the vehicle control module 404 and/or the MODACS control module 403.

The vehicle 400 further includes a HV power source 470 that supplies power via a contactor 472 to an APM 474. The APM 474 operates similarly as the APM 106 of FIG. 1. The APM 474 is in communication with the vehicle control module 404 via the network 410. The APM 474 may charge the MODACS 402 and supply power to various loads, some of which are shown in FIG. 4 including nominal and auxiliary loads.

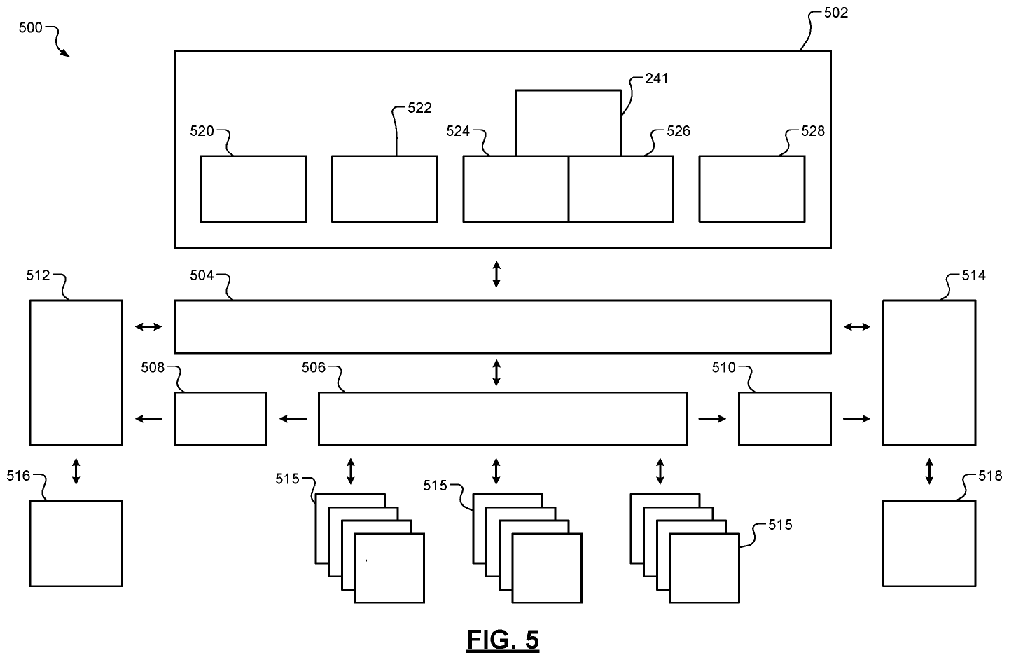

FIG. 5 shows control portion of a vehicle control system 500. The vehicle control system 500 includes: a vehicle control module 502; a switch control layer 504; bus bars and sensors 506; hardware 508, 510; 12V switches 512; 48V switches 514; four series cell stacks (or blocks) 515; 12V loads 516; and 48V loads 518. The vehicle control module 502 may include a safety and onboard diagnostic module 520, a power planning module 522, an automotive safety integrity level (ASIL) module 524, the ASM module 241, an advanced (or autonomous) driving assistance system (ADAS) module 526, and/or a mode module 528. As an example three sets of four blocks are shown. Each set may be referred to as a battery module.

The onboard diagnostic module 520 may perform system diagnostics and reporting. The power planning module 522 may receive power requests and plan power usage over time. In one embodiment, the ASM module 241, the ASIL module 524, and the ADAS module 526 are implemented as a single module. The modules 241, 524, 526 perform safety monitoring, reporting and counterbalancing operations. These operations pertain to states of cells of a MODACS and include monitoring states of the cells and connecting, disconnecting, isolating, cooling, and discharging the cells. The ASIL module 524 may control modes of operation based on current safety status levels of a MODACS and/or vehicle system. The ADAS module 526 may control providing power while operating in an autonomous mode. The mode module 528 may select the operating mode or modes of the vehicle control system 500 and/or portions thereof. The switch control layer 504 may control states of the switches 512, 514. The bus bars and sensors 506 may include 12V and 48V bus bars and sensors for detecting states of the blocks 515.

FIG. 6 shows a portion of a MODACS circuit 600 that includes one or more source terminals. The MODACS circuit 600 may include multi-functional solid-state switches, switch drive circuits, current and voltage sense circuits arranged in a minimum switch count topology to enable on-demand capacity allocation for source terminals having similar or dissimilar preset (or target) voltages. The MODACS circuit 600 is flexible, modular, and has minimum size, complexity, weight, and component count. For at least these reasons, the MODACS circuit 600 minimizes manufacturing difficulty.

As shown, the MODACS circuit 600 includes block sets, where each block set includes 4 cells, 4 or more switches, a BMS module and source terminals with corresponding power rails. An example block set 602 is outlined and includes a block of cells 604, 4 switches 606 and a BMS module 608. The blocks are shown with battery symbols. Three of the switches 606 connect the blocks 604 respectively to source terminals (e.g., a 48V, 12VA, and a 12VB source terminals are shown). The fourth one of the 4 switches 606 connects the block 604 to a ground reference (or negative terminal) 612.

As shown the blocks may be arranged in an array having rows and columns. Each of the blocks may be configured the same except one of the rows closest to the ground reference. In this row, each of the blocks includes three switches instead of four switches. As a result, the corresponding cells are connected to the ground reference without use of switches, as shown.

As can be seen, the blocks may be connected to each of the source terminals. Any block may be connected to any one or more of the source terminals. The first switches in the block sets in one of the rows (or first row) may be connected to the first source terminal (48V source terminal). The first switches in the block sets in one or more intermediate rows (e.g., the second and third rows) may be connected to cell(s) in a previous row. This allows the cell(s) in the blocks in each column to be connected in series. Under certain conditions, the blocks in columns are connected in series to form two or more series of blocks and the multiple series of blocks are connected in parallel to maximize power to the first source terminal.

The MODACS circuit 600 further includes a MODACS control module 620 that controls states of the blocks. The MODACS control module 620 receives BMS signals from the BMS modules and a system capacity request signal from a vehicle control module. Based on priorities of the voltage source terminals, parameters, and power and current demands indicated by the system capacity request signal, the MODACS control module 620 determines a connected configuration and sets states of the switches of the blocks. The parameters may include voltages, power levels, current levels, and temperatures indicated in the BMS signals. The MODACS control module 620 generates an actual capacity allocation signal indicating capacity allocation for the source terminals. The actual capacity allocation may not match the requested capacity allocation depending on: the state of the MODACS including whether there is any faults or shorts; and the SOH of the blocks. The actual capacity allocation signal may be transmitted from the MODACS control module 620 to the vehicle control module.

The MODACS circuit 600 includes a 12V switching matrix, architecture, and switch controls to enable elimination of 12V stabilization using a DC-to-DC converter, such as a 48V to 12V DC-to-DC buck or boost converter, and/or elimination of 12V and/or 48V redundant back-up power. The MODACS circuit 600 has a minimal circuit, block, switch configuration for first power, first voltage (e.g., V1 greater than or equal to 24V) source terminal and at least two second power, second voltage (e.g., two 12V) source terminals. The switches may be solid-state switches for fast noise free reconfiguring. The switches may be configured for bi-directional voltage and current blocking capability to prevent shorts between first and second voltage source terminals. Switches configured for unidirectional voltage and current blocking may be used to minimize losses selectively.

The switches may be implemented in a single chip or in a multi-chip package. The switches may include enhancement mode silicon metal-oxide-semiconductor field-effect-transistors (MOSFETs), gallium nitride (GaN) FETs, silicon carbide (SiC) MOSFETS, insulated-gate bipolar transistors (IGBTs), and/or other suitable switches. The switches may be in an ON state, an OFF state, or a linear operating state for impedance matching purposes. The switches may be integrated together with drivers and interlock logic to prevent short circuits between blocks, between different source terminals, and between a source terminal and a ground reference. The switches are controlled to achieve a desired capacity at each source terminal based on vehicle control module demands and status updates in the form of feedback signals from the BMS modules of the blocks.

In an embodiment, the cells of the blocks are lithium battery cells, but may be other types of cells. The example of FIG. 6 is shown to illustrate a minimalistic architecture having a minimal number of blocks and switches per block set to provide 48V, 12VA and 12VB outputs without a DC-to-DC converter.

The MODACS control module 620 may be configured similarly as the other MODACS control modules 130, 240, 403 referred to herein.

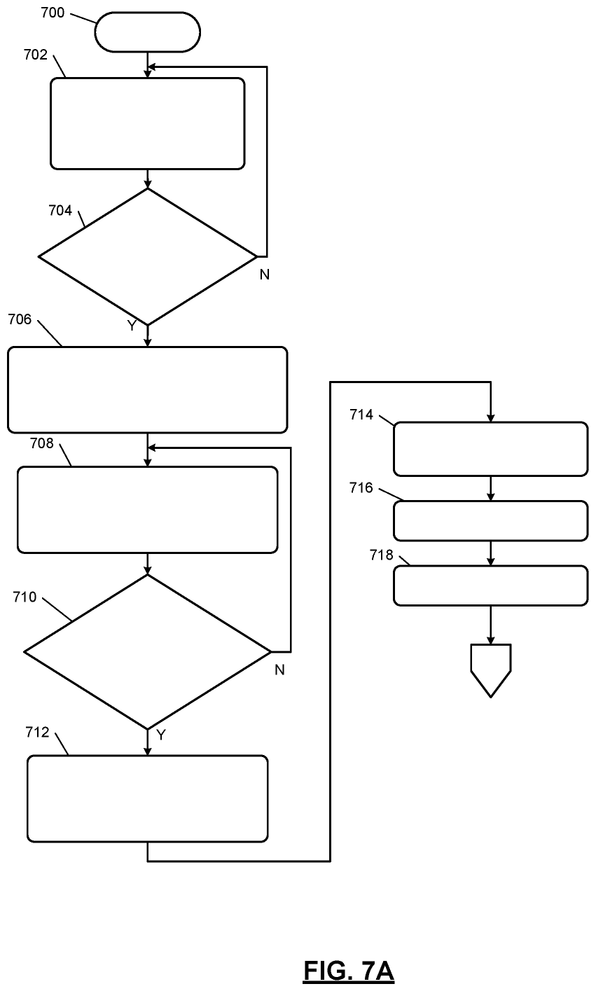

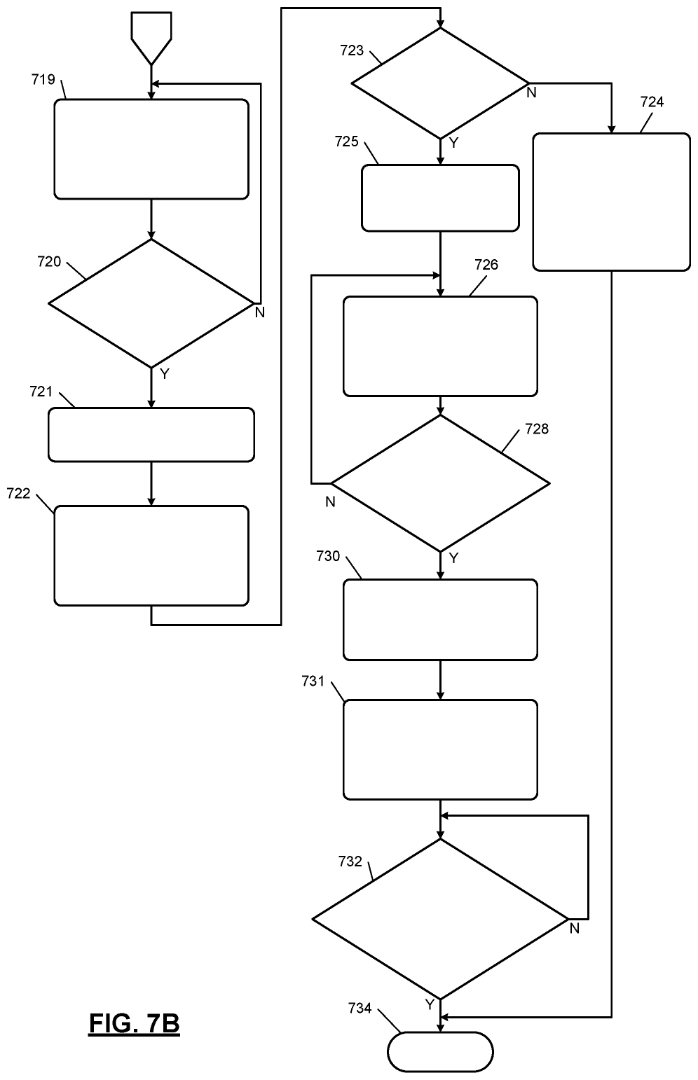

FIG. 7 shows a low-voltage mitigation and recovery method, which may be performed by the low-voltage mitigation and recovery system 100 of FIG. 1 and/or other low-voltage mitigation and recovery system provided by the examples disclosed herein. The following operations may be iteratively performed. In one embodiment, the corresponding host vehicle is parked and the vehicle control module and APM are in a sleep mode at the beginning of this method and may return to this mode at the end of this method. While in the park and sleep mode, the HV power source of the vehicle is not supplying power to a propulsion system (e.g., motors) of the vehicle and the vehicle is parked and not moving. The vehicle may remain parked during this method.

The method may begin at 700. At 702, a MODACS control module, such as one of the MODACS control modules disclosed herein, may monitor parameters of blocks of cells and/or groups of the blocks of the corresponding MODACS. The parameters may include voltages, SOCs, temperatures, etc. of the blocks of cells and/or one or more groups of the blocks of cells. A group may include one or more of the blocks of cells. A group may include all of the blocks of cells. The parameters may be provided via sensors of the MODACS.

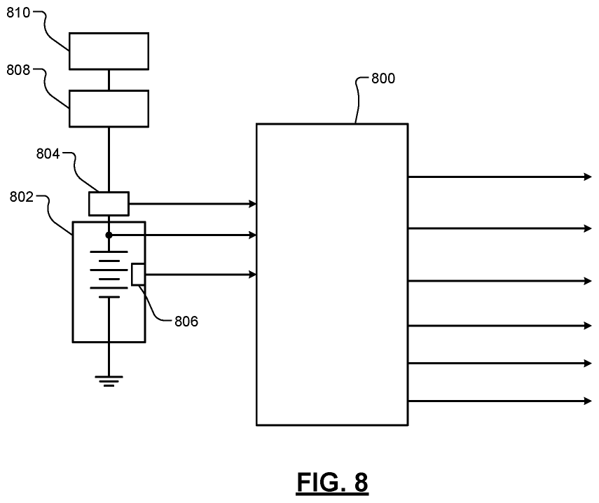

FIG. 8 shows an example battery monitoring (or management) system (BMS) module 800 for a battery pack 802 having any number of cells, blocks, and battery modules. In one embodiment, the battery monitoring system module 800 is provided for each block of cells as part of an ASM system. In the example shown, the BMS module 800 monitors voltages, temperatures, power levels, and current levels of the corresponding one or more cells of the block or pack 802 and determines certain parameters. The parameters may include instantaneous charge and discharge power and current limits, short term charge and discharge power and current limits, and continuous charge and discharge power and current limits. The parameters may also include minimum and maximum voltages, minimum and maximum operating temperatures, and SOX limits and/or values. The parameters output by the BMS module 800 may be determined based on the voltages, temperatures and/or current levels monitored. The charge and discharge power and current capability of a 12V block or pack is affected by the minimum and maximum voltages, minimum and maximum operating temperatures, and SOX limits and/or values of the corresponding cells. The BMS module 800 may monitor individual cell voltages, temperatures and current levels and determine based on this information the stated parameters. The parameters output by the BMS module 800 are shown as arrow out of the BMS module 800. The parameters received by the BMS module 800 are shown as arrow directed to the BMS module 800. The BMS module 800 may generate safety fault signals when certain safety fault conditions are detected, such as the safety fault conditions referred to herein.

As an example, the BMS module 800 may include and/or be connected to sensors, such as a current sensor 804 and a temperature sensor 806, which may be used to detect current levels through the cells of block or pack 802 and temperatures of the block or pack 802. As an example, a voltage across the block or pack may be detected as shown. In an embodiment, one or more voltage sensors may be included to detect voltages of the block or pack 802. The current sensor 804 may be connected, for example, between the block or pack 802 and a source terminal 808, which may be connected to a load 810. The temperatures, voltages, and current levels are reported to the BMS module 800 and/or the ASM module 241 (shown in FIGS. 2-6) as some of the parameters received by the BMS module 800. In one embodiment, the BMS module 800 and/or one or more coulombic counters are used to determine the SOCs and whether the SOCs are below corresponding first thresholds.

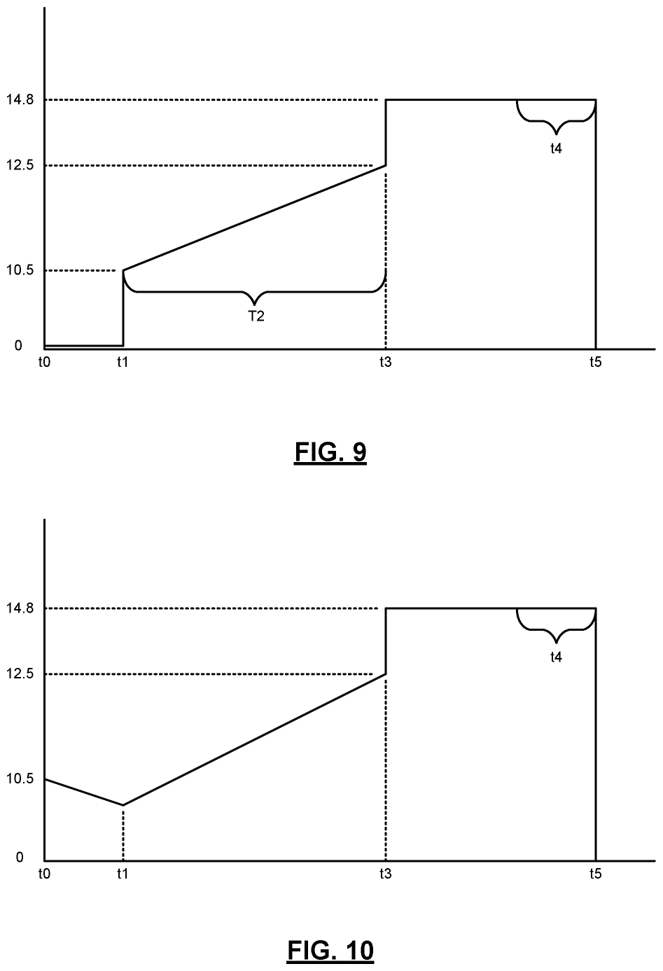

Referring again to FIGS. 7A-7B and to FIGS. 9-10, the following operations are described with respect to the examples of FIGS. 9-10. FIG. 9 shows a plot of APM voltage versus time. FIG. 10 shows a plot of a MODACS voltage versus time.

At 704, the MODACS control module determines whether the parameters are indicative of the MODACS being in a low-voltage state. As an example, the MODACS control module may determine that a low-voltage state exists based on: minimum and maximum cell temperature thresholds; minimum and maximum SOC thresholds; minimum and maximum cell voltage thresholds; and/or detected temperatures, SOCs and voltages of the cells, blocks of cells, and/or groups of the blocks of cells. For example, the voltages and/or SOCs of one or more blocks of cells may be below first thresholds indicative of being in a low-voltage state. As an example, when the voltage of one or more blocks and/or one or more groups is less than or equal to 10.5-11.5V, then the MODACS control module may operate in the low-voltage mode. If a low-voltage state exists, operation 706 is performed, otherwise operation 702 may be performed. This determination may be made, for example, at time t0, which is shown in FIGS. 9-10.

At 706, the MODACS control module may disconnect one or more of the blocks of cells of the MODACS from all loads and maintain connection with the remaining blocks of cells to selected loads. For example, the MODACS may have 9 blocks (or strings) of serially and/or parallelly connected cells. The MODACS control module may disconnect blocks 7-9 from loads and utilize blocks 1-6 for supplying power to one or more types of loads and/or one or more specific loads. As an example, blocks 7-9 may be disconnected from nominal, auxiliary, transient and leakage current loads and blocks 1-6 may be used to supply power to selected auxiliary and leakage current loads. Blocks 1-6 may be prevented from supplying power to one or more nominal loads and/or one or more transient loads. As another example, blocks 1-6 may be prevented from supplying power to one or more auxiliary loads and/or one or more transient loads. The MODACS control module may configure connections between cells and to bus bars to i) connect or maintain connection of a first set of blocks of cells to provide power for selected loads, and ii) disconnect and thus isolate a second set of blocks of cells. This is helpful when recovering from being in an undervoltage protection mode when switches to certain blocks of cells are open.

The disconnecting of blocks from loads and the preventing of blocks from supplying power to certain selected loads i) prevents power from being drawn from disconnected blocks, and/or ii) reduces the amount of power being drawn from the blocks being used to supply power. This reduces the rate of discharge of the MODACS to extend the available usage time of the MODACS and/or the remaining time that the MODACS may be used to start up the vehicle.

The MODACS control module may separate the blocks of cells into two groups, one that is disconnected to preserve power for starting the vehicle and the other to supply power to a reduced number of possible loads. The MODACS control module may select i) any of the blocks and any number of the blocks to disconnect, and ii) any of the blocks and any number of the blocks to use for supplying power.

In one embodiment, the second set of blocks (e.g., blocks 7-9) are disconnected from supplying power to operate nominal, auxiliary and transient loads, but are connected to cover leakage current loads. In this example, the second set of blocks are not fully disconnected from all loads, but rather are connected to provide power to handle leakage current loads. In another embodiment, the first set of blocks handle the leakage current loads and the second set of blocks do not handle the leakage current loads. Leakage current loads may reduce SOCs of connected blocks 4-5% per month that a host vehicle is parked and a corresponding propulsion system is not in use.

In another embodiment, the dividing up of the blocks of the MODACS into a first set that is disconnected and a second set that is maintained in a connected state for supplying power to loads is determined based on the SOH of the blocks of the MODACS. As an example, a predetermined number of blocks (e.g., 2-4) with highest SOH may be disconnected, whereas the other blocks may remain connected and used to supply power to loads. As another example, a predetermined number of blocks (e.g., 2-4) with a lowest SOH may be disconnected and the other blocks may remain connected and used to supply power to loads.

At 708, the MODACS control module may monitor the parameters of the blocks and/or groups of the MODACS, as performed at 702.

At 710, the MODACS control module may determine whether the parameters are indicative of the MODACS being in a state for requesting operation in a recovery mode. For example, when the voltages and/or SOCs of one or more blocks and/or one or more groups are below second thresholds, then the MODACS may be in a recovery appropriate state to operate in the recovery mode. The MODACS control module may switch to operating in the recovery mode when the voltage of one or more blocks is within 0.1V of an undervoltage calibration voltage (e.g., 10.0V) at which point the MODACS control module would disconnect the one or more blocks from all loads. As an example, when the voltage of one or more blocks and/or one or more groups is less than or equal to 10.0V-10.5V, then the MODACS control module may operate in the recovery mode. In an embodiment, operation in the recovery mode may occur when a voltage of a predetermined number (e.g., 3) of blocks (disconnected and/or connected) is less than or equal to a second threshold (e.g., 10.0V). In an embodiment, operation in the recovery mode may occur when a voltage of one or more of the disconnected blocks is less than or equal to a second threshold (e.g., 10.0V). When in the recovery appropriate state, operation 712 is performed, otherwise operation 708 may be performed.

As another example, the MODACS control module may operate in the recovery mode and operation 712 may be performed when, for example, i) the voltage of one or more blocks is below a predetermined threshold, ii) a SOC of the one or more blocks is at 0%, iii) a measured minimum temperature (e.g., 20° C.) of the one or more blocks is greater than or equal to than a first predetermined temperature, and iv) a measured maximum temperature (e.g., 50° C.) of the one or more blocks is less than or equal to a second predetermined temperature.

At 712, the MODACS control module signals a vehicle control module, such as one of the vehicle control modules referred to herein, to wake up an APM (e.g., one of APMs 106, 474 of FIGS. 1 and 4) and close a contactor (e.g., one of contactors 104, 472 of FIGS. 1 and 4) supplying HV power to the APM to charge the MODACS. This may include the MODACS control module setting a jumpstart flag in memory from false to true. The jumpstart flag may be accessible to the vehicle control module and/or the APM and indicate whether the vehicle control module should wakeup and provide power to the MODACS via the APM. The MODACS control module sends a wakeup signal to the vehicle control module, which may be over a network, such as the network bus 120 or 410 of FIGS. 1 and 4. The wakeup signal may indicate the MODACS is in a state for recovery. The wakeup signal may indicate which and/or a number of blocks of the MODACS that are low on energy and the corresponding voltage and/or SOCs of the blocks that are low on energy. The wakeup signal may be a command signal instructing the vehicle control module to charge the MODACS or may be a request signal based on which the vehicle control module determines whether to charge the MODACS. The wakeup signal may be generated at time t1, which is shown in FIGS. 9-10.

At 714, the vehicle control module commands the APM to a minimum output voltage setting. This may be a lowest calibratable setting. For example, the output voltage of the APM may be 10.0V initially. This is to assure that the APM output voltage is not greater than the current MODACS voltage by more than a set threshold. By setting the output voltage of the APM to a minimum setting, a large inrush of current from the APM to the MODACS is prevented when connecting the HV power source to the buses of the MODACS to charge the blocks of the MODACS.

At 716, the vehicle control module and/or APM selects the rate of charging. As a couple of examples, the rate of charge may be a slow rate of charge or a fast rate of charge. An example of a slow rate of charge is represented by equation 1, where t is time and V_{APM} is the APM output voltage. An example of a fast rate of charge is represented by equation 2.

V_{APM}=10.5+0.1t (1)

V_{APM}=10.5+t (2)

In the examples of equations 1-2, the initial starting APM output voltage is 10.5 V and the rates of increase in APM output voltage is 0.1 and 1.0, respectively. Other initial APM output voltages and rates of increase may be selected by the vehicle control module and/or APM. The initial low APM output voltage and the ramp up of the APM output voltage protects the contactor and switches (e.g., field effect transistors) of the switch network of the MODACS from increased resistance over time and prevents welding of contacts/terminals of the contactor and/or switches.

At 718, the APM ramps up the APM output voltage at the selected rate. This is represented by the increase in APM output voltage shown in FIG. 9 for period t2. At 719, the MODACS control module may monitor the parameters of the blocks and/or groups of the MODACS, as performed at 702.

At 720, the MODACS control module may determine whether the APM output voltage is greater than or equal to the voltage of one or more blocks of the MODACS by more than a predetermined amount (e.g., 0.1-0.5V). If yes, operation 721 is performed, otherwise operation 719 is performed.

At 721, the MODACS control module closes one or more of the switches of the switch network of the MODACS to charge selected blocks of the MODACS. In one embodiment, the non-isolated blocks (e.g., blocks 1-6) are charged and the isolated blocks (e.g., blocks 7-9) are not charged. At some point during period t2, the APM output voltage will match and then exceed the MODACS voltage. This may occur, for example, when the APM output voltage is 11.0V and the MODACS voltage is 10.5V. At this point, the MODACS control module closes selected ones of the switches of the MODACS to charge the blocks of the MODACS. At 722, the MODACS control module may monitor the parameters of the blocks and/or groups of the MODACS, as performed at 702.

At 723, the MODACS control module may determine whether the MODACS is charging appropriately. For example, the MODACS control module may determine whether a voltage, SOC and/or temperature of one or more blocks of cells indicate that charging is not occurring, temperatures are increasing at a rate above normal for charging, a voltage and/or SOC is changing at a rate that is outside a predetermined normal rate of charging, etc. The MODACS control module may confirm whether the selected ones of the switches that were commanded closed are actually closed. If charging inappropriately, the MODACS control module may signal the vehicle control module and/or the APM that charging is not occurring appropriately and operation 724 may be performed. If charging appropriately, the MODACS control module may signal the vehicle control module and/or the APM that charging is occurring appropriately and operation 725 may be performed.

At 724, the MODACS control module may operate in an undervoltage protection mode. This may include signaling the vehicle control module and/or the APM and disconnecting one or more of the blocks of the MODACS. If not already disconnected, the one or blocks that are not charging appropriately may be disconnected from the APM by opening the corresponding ones of the switches of the switch network of the MODACS. In one embodiment, the vehicle control module and/or APM may close the contactor to cease charging of the MODACS.

In another embodiment, the MODACS control module disconnects and thus isolates the one or more blocks that are not charging appropriately and permits other blocks to be charged. This may include performing operations 725-732 while maintaining isolation of the one or more blocks that are not charging appropriately.

At 725, the vehicle control module and/or the APM increases the APM output voltage to a maximum charging voltage (e.g., 14.8V) to charge the MODACS at an increased rate (e.g., 2-3C, where 1C refers to a rate of charge to be fully charged in 1 hour) to charge the previously non-isolated blocks (e.g., one or more of blocks 1-6) that were not disconnected at 724. This is represented by time t3 in FIGS. 9-10. At time t3, the APM output voltage and the voltage of the blocks being charged are at an intermediate voltage (e.g., 12.5V), as shown in FIGS. 9-10. The maximum charge current I1 is equal to the APM nominal power divided by the maximum charging voltage (e.g., 14.8V). If the APM nominal power is 2.96 kilowatts (kW), then I1 is 200 Amperes (A). A battery charging look-up table (LUT) may be used to determine the maximum charging voltage and corresponding charging current. The charging current determined using the battery charging LUT may be designated I2. In one embodiment, if I2 is greater than I1, then I1 is used as the maximum charging current until I2 is less than I1, then I2 is used as the maximum charging current.

At 726, the MODACS control module may monitor the parameters of the blocks and/or groups of the MODACS, as performed at 702.

At 728, the MODACS control module determines whether the SOCs of the non-isolated blocks are greater than a first predetermined SOC (e.g., 80%). If yes, operation 730 may be performed, otherwise operation 726 may be performed.

At 730, the MODACS control module connects and charges the one or more blocks of the MODACS that were disconnected at 706. The MODACS control module may charge, at this point, i) the previously non-isolated blocks that were not disconnected at 724, and ii) the previously isolated blocks. At 731, the MODACS control module may monitor the parameters of the blocks and/or groups of the MODACS, as performed at 702. In one embodiment, the MODACS control module performs an operation similarly to operation 723 to determine if the blocks connected at 730 are charging appropriately. If one or more are not charging appropriately, an operation similar to operation 724 may be performed to at least isolate the one or more blocks that are not charging appropriately.

At 732 the MODACS control module determines whether the SOCs of the blocks of the MODACS are greater than a second predetermined SOC (e.g., 90-95%). The second predetermined threshold may be higher than the first predetermined threshold. If yes, charging may stop and the method may end at 734. This is represented by time t5 in FIGS. 9-10.

The above-described examples allow CAN signals or other network signals to be transmitted for low-voltage and recovery mode operations. The examples allow a MODACS (sometimes referred to as a “battery”) to protect against undervoltage scenarios. Voltage setpoints are used as triggers during charging and recovery process. The examples include splitting up blocks of a MODACS into two groups (or sets) of blocks. A first set of blocks is charged using power from a HV power source. The second set of blocks may be operated in a constant voltage mode to supply power to selected loads. By dividing the blocks of the MODACS into two groups, selected loads and parasitic draw are handled by some blocks of cells, while other blocks of cells are isolated to protect energy capacity of the other block of cells for quicker recovery of the MODACS. The examples include the use of a coulombic counter to track real SOCs, APM controls that prevent overcharging, and block (or string) priority for charging based on SOH and isolation criteria.

The examples described herein eliminate the need for external intervention from a device separate from a vehicle to jumpstart a MODACS (or battery) of the vehicle to recover the MODACS; and/or the need to have an external device close low-voltage contactors (or switches) to charge the MODACS. The disclosed algorithm allows a vehicle to “self-recover” a MODACS when the MODACS is in a state for recovery. The examples also allow recovery when parasitic draw increases and/or draw from other loads (e.g., external auxiliary loads) increases and quickly draws down voltages and SOCs of blocks of a MODACS.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

Although the terms first, second, third, etc. may be used herein to describe various elements, components, and/or devices, these elements, components, and/or devices should not be limited by these terms, unless otherwise indicated. These terms may be only used to distinguish one element, component, or device from another element, component, or device. Terms such as “first,” “second,” and other numerical terms when used herein do not imply a sequence or order unless clearly indicated by the context. Thus, a first element, component, or device could be termed a second element, component, or device without departing from the teachings of the example embodiments.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A low-voltage mitigation and recovery system comprising:
an auxiliary power module configured to convert an output voltage of a power source of a vehicle to a charging voltage, the power source configured to provide power to power a propulsion system of the vehicle;
a contactor configured to supply power from the power source to the auxiliary power module;
a first control module configured to control states of the auxiliary power module and the contactor; and
a second control module configured to be integrated within a multiple output dynamic adjustable capacity battery system (MODACS) of the vehicle, monitor at least one parameter of one or more blocks of cells of the MODACS, and, based on at least one parameter of the one or more blocks of cells of the MODACS, i) configure a switch network of the MODACS to (a) disconnect a first set of blocks of the MODACS from loads of the vehicle, and (b) connect or maintain connection of a second set of blocks of the MODACS to selected ones of the loads, and ii) wake up the first control module to jump start and recover the MODACS.

2. The low-voltage mitigation and recovery system of claim 1, wherein the second control module in response to:
the at least one parameter being less than a first predetermined voltage, (a) disconnects the first set of blocks from the loads of the vehicle, and (b) connects or maintains connection of the second set of blocks to the selected ones of the loads; and
the at least one parameter being less than a second predetermined voltage, wakes up the first control module to jump start and recover the MODACS.

3. The low-voltage mitigation and recovery system of claim 1, wherein the first control module is configured to in response to receiving a wake-up signal from the second control module to jump start and recover the MODACS, close the contactor and instruct the auxiliary power module to output a minimum voltage for charging the MODACS.

4. The low-voltage mitigation and recovery system of claim 3, wherein the first control module is configured to ramp up an output voltage of the auxiliary power module at a selected rate.

5. The low-voltage mitigation and recovery system of claim 4, wherein the second control module is configured to close one or more of switches of the switch network to begin charging a selected at least one block of cells of the MODACS in response to the output voltage of the auxiliary power module exceeding a voltage of the selected one or more blocks of cells by a predetermined amount.

6. The low-voltage mitigation and recovery system of claim 5, wherein the selected at least one block of cells includes the selected one or more blocks of cells.

7. The low-voltage mitigation and recovery system of claim 1, wherein the second control module is configured to wake up the first control module in response to a voltage of the one or more blocks being within 0.1V of an undervoltage calibration voltage.

8. The low-voltage mitigation and recovery system of claim 1, wherein the second control module is configured to determine whether at least one block of cells of the MODACS is charging appropriately during recovery of the MODACS, and in response to the at least one block of cells charging appropriately, increase a charging rate of the second set of blocks.

9. The low-voltage mitigation and recovery system of claim 8, wherein the second control module is configured to determine whether a state-of-charge of the at least one block of cells of the MODACS is greater than a first predetermined state-of-charge, and in response to the at least one block of cells of the MODACS being greater than the first predetermined state-of-charge, connect the first set of blocks to charge the first set of blocks.

10. The low-voltage mitigation and recovery system of claim 1, wherein the second control module is configured to determine whether at least one block of cells of the MODACS is charging appropriately during recovery of the MODACS, and in response to the at least one block of cells charging inappropriately, operate in an undervoltage protection mode.

11. A low-voltage mitigation and recovery system comprising:
an auxiliary power module configured to convert an output voltage of a power source of a vehicle to a charging voltage, the power source configured to provide power to power a propulsion system of the vehicle;
a contactor configured to supply power from the power source to the auxiliary power module;
a vehicle control module configured to control states of the auxiliary power module and the contactor; and
a control module configured to be integrated within a battery of the vehicle, monitor at least one parameter of one or more blocks of cells of the battery, and, based on at least one parameter of one or more blocks of cells of the battery, i) configure a switch network of the battery to (a) disconnect a first set of blocks of the MODACS from loads of the vehicle, and (b) connect or maintain connection of a second set of blocks of the MODACS to selected ones of the loads, and ii) wake up the vehicle control module to jump start and recover the battery.

12. A method of operating a low-voltage mitigation and recovery system, the low-voltage mitigation and recovery system comprising an auxiliary power module, a contactor, a first control module and a second control module, the auxiliary power module being configured to convert an output voltage of a power source of a vehicle to a charging voltage, the power source configured to provide power to power a propulsion system of the vehicle, the contactor being configured to supply power from the power source to an the auxiliary power module, the first control module being configured to control states of the auxiliary power module and the contactor, and the second control module being integrated within a multiple output dynamic adjustable capacity battery system (MODACS) of the vehicle, the method comprising:
monitoring, via the second control module, at least one parameter of one or more blocks of cells of the MODACS; and
based on at least one parameter of the one or more blocks of cells of the MODACS, i) configuring a switch network of the MODACS to (a) disconnect a first set of blocks of the MODACS from loads of the vehicle, and (b) connect or maintain connection of a second set of blocks of the MODACS to selected ones of the loads, and ii) waking up the first control module to jump start and recover the MODACS.

13. The method of claim 12, further comprising via the second control module and in response to:
the at least one parameter being less than a first predetermined voltage, (a) disconnecting the first set of blocks from the loads of the vehicle, and (b) connecting or maintaining connection of the second set of blocks to the selected ones of the loads; and
the at least one parameter being less than a second predetermined voltage, waking up the first control module to jump start and recover the MODACS.

14. The method of claim 12, further comprising, via the first control module and in response to receiving a wake-up signal from the second control module to jump start and recover the MODACS, closing the contactor and instructing the auxiliary power module to output a minimum voltage for charging the MODACS.

15. The method of claim 14, further comprising, via the first control module, ramping up an output voltage of the auxiliary power module at a selected rate.

16. The method of claim 15, further comprising, via the second control module, closing one or more of switches of the switch network to begin charging a selected at least one block of cells of the MODACS in response to the output voltage of the auxiliary power module exceeding a voltage of the selected one or more blocks of cells by a predetermined amount.

17. The method of claim 12, further comprising, via the second control module, waking up the first control module in response to a voltage of the one or more blocks being within 0.1V of an undervoltage calibration voltage.

18. The method of claim 12, further comprising, via the second control module, determining whether at least one block of cells of the MODACS is charging appropriately during recovery of the MODACS, and in response to the at least one block of cells charging appropriately, increasing a charging rate of the second set of blocks.

19. The method of claim 18, further comprising, via the second control module, determining whether a state-of-charge of the at least one block of cells of the MODACS is greater than a first predetermined state-of-charge, and in response to the at least one block of cells of the MODACS being greater than the first predetermined state-of-charge, connecting the first set of blocks to charge the first set of blocks.

20. The method of claim 12, further comprising, via the second control module, determining whether at least one block of cells of the MODACS is charging appropriately during recovery of the MODACS, and in response to the at least one block of cells charging inappropriately, operating in an undervoltage protection mode.
